(19) United States
(12) Patent Application Publication
(10) Pub. No.: US 2004/0240496 A1
(43) Pub. Date: Dec. 2, 2004

(54) Rod type solid state laser

(76) Inventors: Shuichi Fujikawa, Tokyo (JP); Susumu Konno, Tokyo (JP); Tetsuo Kojima, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/500,247

(22) PCT Filed: Feb. 15, 2002
(86) PCT No.: PCT/JP02/01316

(51) Int. Cl. H01S 3/04; H01S 3/091

(52) U.S. Cl. 372/34; 372/75

(57) ABSTRACT

A rod-shaped solid-state laser apparatus that, in a support structure for the rod-shaped solid-state laser, can generate a stable laser beam. The rod-shaped solid-state laser apparatus includes: a fixing ring, placed around one end of the solid-state laser medium, having part or all of its outer face tapered. A rod holder is placed around the fixing ring, and has a face, facing the fixing ring and tapered at an angle approximately equal to the tapered outer face of the fixing ring. The fixing ring is pressed against the tapered inner face of the rod holder, and also against the solid-state laser medium. The solid-state laser medium is fixed to the rod holder.

### TECHNICAL FIELD

The present invention relates to rod-type solid-state laser apparatuses, and particularly to rod support structures for stably extracting laser beams from rod-type solid-state laser media.

### BACKGROUND ART

FIG. 6, as an example, is a cross sectional configuration diagram illustrating the structure of a solid-state-laser-medium support member for a conventional rod-type solid-state laser apparatus, as described by Kochner in “Solid-state Laser Engineering”, 3rd Edition, page 375. In FIG. 6, numeral 1 denotes a rod-type solid-state laser medium, having circular cross sections, whose end faces have been cut at Brewster's angle, and numeral 2 denotes a rod holder provided with a through-hole for fixing the solid-state laser medium 1, with an O-ring groove provided inside the through-hole. Numeral 3 denotes a rod-fixing O-ring used to support an end of the rod-type solid-state laser medium and also to seal in a coolant medium that cools the solid-state laser medium 1, and is located inside the O-ring groove provided inside the through-hole of rod holder 2. Numeral 4 denotes a side plate for fixing the rod holder 2; numeral 5 denotes a water coolant channel provided in the side plate 4 for supplying or discharging the coolant medium that cools the solid-state laser medium 1; numeral 6 denotes a rod-holder O-ring that, when fixed to the side plate 4, is used to seal in the coolant medium; and numeral 7 denotes a flow tube, provided for circulating the coolant medium around the solid-state laser medium 1, with the solid-state laser medium 1 fixed by the rod holder 2 so as to be enclosed in the flow tube 7. Numeral 8 denotes a flow-tube O-ring that, when the flow-tube 7 is fixed to the side plate 4, is used to seal in the coolant medium. While FIG. 6 shows a configuration for fixing one end of the solid-state laser medium 1, the other end of the solid-state laser medium 1 is also fixed according to the same configuration. In this case, the coolant medium, supplied from the water coolant channel 5 provided on one of the side plates, while cooling the solid-state laser medium 1 via the flow tube 7, reaches water coolant channel 5 on the other of the side plates, and is then discharged to the outside.

FIG. 7, as an example, is a cross sectional configuration diagram illustrating the structure of a solid-state laser medium support member in another conventional rod-type solid-state laser, as disclosed in Japanese Unexamined Utility Model Application No. 06-082873. In FIG. 7, numerals 1, 2 and 3 denote similar members to those shown in FIG. 6. Numeral 20 denotes a cap that is screwed onto the rod holder 2, bearing down on the O-ring 3 via a back-up ring 30 through the open end of the rod holder 2. The cap 20 and the back-up ring 30 function as holding-down members that prevent the O-ring 3 from coming off.

As described above, in conventional rod-type solid-state lasers, both ends of the solid-state laser medium are supported by O-rings 3, used for sealing in the coolant medium. Since the O-rings 3 have this additional function of supporting the solid-state laser medium 1, in conventional apparatuses there has been a risk that fixation of the solid-state laser medium may become unstable.

An object of the present invention, which has been made to solve the foregoing problems, is to obtain a rod-type solid-state laser that stably supports a solid-state laser medium and outputs a stable laser beam.

### DISCLOSURE OF INVENTION

In a first aspect of this invention, a rod-type solid-state laser apparatus includes: a rod-type solid-state laser medium; a pair of fixing rings, each placed around an end of the solid-state laser medium and having an inner diameter approximately equal to the diameter of the solid-state laser medium, and formed with part or all of its outer face tapered; a pair of rod holders, each placed around one of the fixing rings and having a tapered inner face facing the fixing ring and tapered at an angle approximately equal to the tapered outer face of the fixing ring; and a pair of pressing members each for pressing one of the fixing rings to one of the rod holders on its tapered inner face and also to the solid-state laser medium, and for fixing the solid-state laser medium to the rod holder. According to this arrangement, it is possible to keep effectively under control solid-state laser medium vibration that accompanies direct collision of coolant water against the medium, turbulence in cooling, and other mechanical disturbances, and the solid-state laser medium can be stably supported. As a result, it is possible to stably maintain constant laser output power.

In a second aspect of this invention, the rod-type solid-state laser apparatus includes: a rod-type solid-state laser medium; a pair of fixing rings, each placed around an end of the solid-state laser medium and having an inner diameter being approximately equal to the diameter of the solid-state laser medium, and composed of material having a Young's modulus greater than or equal to 300 MPa and less than the Young's modulus of the solid-state laser medium; a pair of rod holders each placed around one of the fixing rings and each having a tapered inner face; and a pair of pressing members each for pressing one of the fixing rings to the tapered inner face of one of the rod holders and also to the solid-state laser medium, and for fixing the solid-state laser medium to the rod holder. According to this arrangement, because a fixing ring in the present invention, which has high rigidity compared to silicone rubber which is used as a material in conventional O-rings, can securely fix both ends of the rod-type solid-state laser medium, it is possible to keep effectively under control solid-state laser medium vibration that accompanies direct collision of coolant water against the medium, turbulence in cooling, and other mechanical disturbances, to stably maintain constant laser output power.

In a third aspect of this invention, the rod-type solid-state laser apparatus includes: a rod-type solid-state laser medium; a pair of fixing rings, each placed around an end of the solid-state laser medium and having an inner diameter being approximately equal to the diameter of the solid-state laser medium, and formed with a cylindrically shaped face facing the solid-state laser medium; a pair of rod holders each placed around one of the fixing rings and each having a tapered inner face; and a pair of pressing members each for pressing one of the fixing rings to the tapered inner face of one of the rod holders and also to the solid-state laser medium, and for fixing the solid-state laser medium to the rod holder. According to this arrangement, because a fixing ring in the present invention, which has wide surface contact areas with the fixed laser medium as compared to O-rings, can securely fix both ends of the rod-type solid-state laser medium, it is possible to keep effectively under control solid-state laser medium vibration that accompanies direct collision of coolant water against the medium, turbulence in cooling, and other mechanical disturbances, to stably maintain constant laser output power.

In the rod-type solid-state laser apparatuses of this invention described in the above three aspects, a space is provided for setting an O-ring in each rod holder, and the O-ring set in this space is used to seal the coolant medium that cools the solid-state laser medium. According to this arrangement, when using a fixing ring to fix the solid-state laser medium, stresses in the solid-state laser medium can be reduced and optical distortion can be suppressed, with the effect that a laser beam can be stably generated without deterioration in light focusing.

In the rod-type solid-state laser apparatus of this invention described in the first aspect, a fixing ring is made of material having a Young's modulus greater than or equal to 300 MPa, and less than the Young's modulus of the solid-state laser medium. According to this arrangement, because the fixing ring has high rigidity and can fix both ends of the rod-type solid-state laser medium more securely, it is possible to further control vibration in the solid-state laser medium.

In the above rod-type solid-state laser apparatuses or in the rod-type solid-state laser apparatuses of this invention described in the first or second aspects, a fixing ring face which faces the solid-state laser medium has a cylindrical shape. According to this arrangement, because of the wide surface contact area between the fixing ring and the solid-state laser medium, and the ability to fix both ends of the rod-type solid-state laser medium more securely, it is possible to further control vibration in the solid-state laser medium.

In the rod-type solid-state laser apparatuses of the invention described in the above three aspects, the fixing ring material is a fluorinated resin. According to this arrangement, even if the fixing ring is located close to the laser beam, it is possible to constantly maintain stable laser generation without giving rise to heat degeneration or degassing. Additionally, even if a fixing ring is located to be continually in contact with the coolant water, it is possible to keep the electrical conductivity of the purified water at a low value without giving rise to corrosion or degradation, and to maintain a clean coolant medium.

In the rod-type solid-state laser apparatuses of the invention described in the above three aspects, the solid-state laser medium is pumped by a semiconductor laser beam. According to this arrangement, by using a small-diameter solid-state laser medium, it is possible to realize a stable, high efficiency, high output-power, high quality laser beam.

### BRIEF DESCRIPTION OF DRAWINGS

FIG. 1 is a sectional configuration view illustrating the structure of a rod-type solid-state laser apparatus in Embodiment 1 of the present invention; FIG. 2 is a sectional configuration view illustrating the structure of a rod-type solid-state laser medium support member for a solid-state laser apparatus in solid-state laser medium support member for a rod-type solid-state laser apparatus in Embodiment 2 of the present invention; FIG. 3 is a sectional configuration view illustrating the structure of a solid-state laser medium support member for a rod-type solid-state laser apparatus in Embodiment 3 of the present invention; FIG. 4 is a sectional configuration view illustrating the structure of a solid-state laser medium support member for a rod-type solid-state laser apparatus in Embodiment 4 of the present invention; FIG. 5 is a sectional configuration view illustrating the structure of a solid-state laser medium support member for a rod-type solid-state laser apparatus in Embodiment 5 of the present invention; FIG. 6 is a sectional configuration view illustrating the structure of a solid-state laser medium support member for a conventional rod-type solid-state laser apparatus; and FIG. 7 is a sectional configuration view illustrating the structure of a solid-state laser medium support member in another conventional rod-type solid-state laser apparatus.

### BEST MODE FOR CARRYING OUT THE INVENTION

Embodiment 1.

As described above, in rod-type solid-state laser apparatuses, solid-state laser media are supported by O-rings and intensity of supporting is not sufficient; however, in conventional lasers the problem of solid-state laser medium vibration has not occurred. Where a solid-state laser medium is pumped by a pumping source such as a lamp, since pumping light emitted from the lamp radiates omni-directionally and isotropically, when using a solid-state laser medium that is a small-diameter rod, it has been difficult to make the solid-state laser medium absorb the pumping light effectively. Accordingly, laser media having rod diameters greater than or equal to 6 mm have conventionally been used. Further, where a solid-state laser medium is pumped by a pumping source such as a lamp, when it is desire to obtain a high power, high quality laser beam, with heat generation in the solid-state laser medium being large, it has not been possible to make the rod diameter of the solid-state laser medium small in order to raise the quality of the output laser beam. Therefore, there have been no problems, such as vibrations, in solid-state laser media having conventional rod diameters. However, where a solid-state laser medium is pumped by a semiconductor laser beam, since the semiconductor laser has directionality, even if the rod diameter is small, it is possible to radiate the pumping light efficiently onto the solid-state laser medium. Where a solid-state laser medium is pumped by a semiconductor laser beam, since the amount of heat generated is small, it is possible to make the rod diameter of the solid-state laser medium small, and to obtain a high power, high quality laser beam. As a result of experiments, the inventors have found the following problems: in this type of solid-state laser medium having a small-sized rod diameter, where an apparatus configuration is the same as a conventional one, if the rod diameter is less than 4 mm, the solid-state laser medium cannot be fixed securely, and vibration of the solid-state laser medium due to turbulent flow of the coolant medium or external mechanical disturbances becomes significant; and because the influence of the vibration on the stability of the laser oscillation becomes larger, as the rod diameter becomes smaller, the laser oscillation becomes unstable and a stable laser output power cannot be obtained.

The following further problems have been found: because the central optical axis of the solid-state laser medium may easily become eccentric due to turbulent flow of the coolant medium or external mechanical forces when the rod diameter of the solid-state laser medium is less than 4 mm, in a configuration where a plurality of solid-state laser media is arranged in series to generate a high-power laser beam, the position of the central optical axis changes for each rod, lowering the laser-beam generating efficiency.

Configurations to solve these problems are illustrated below.

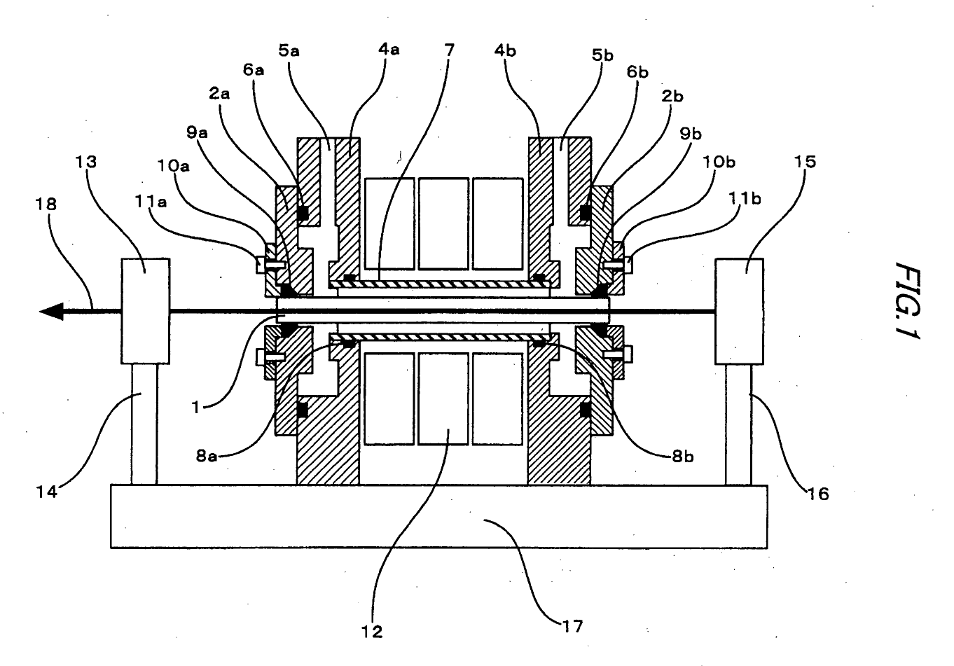

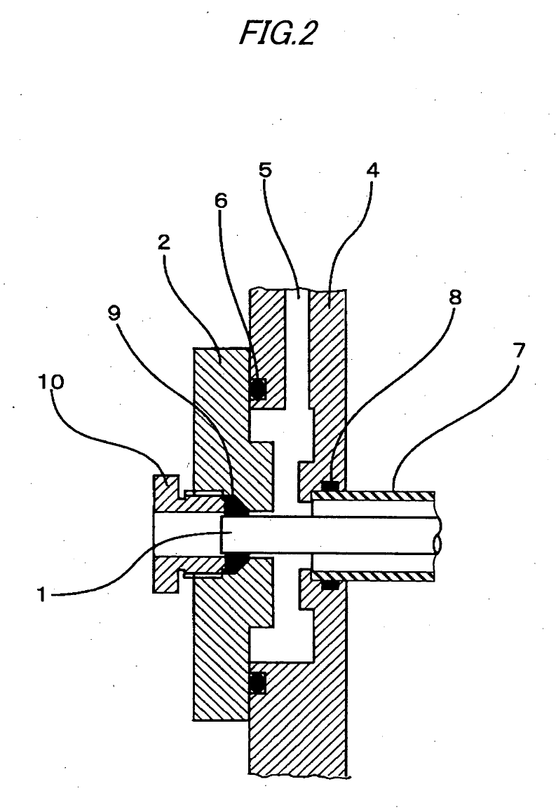

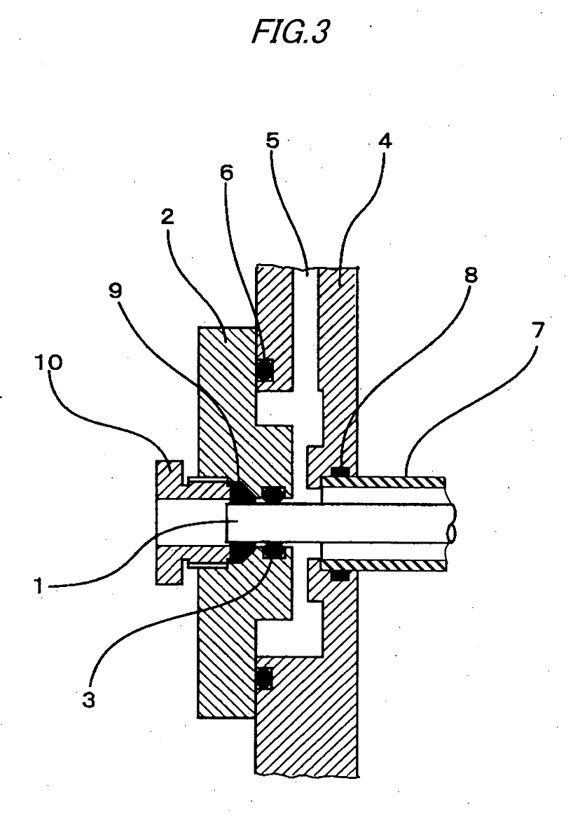

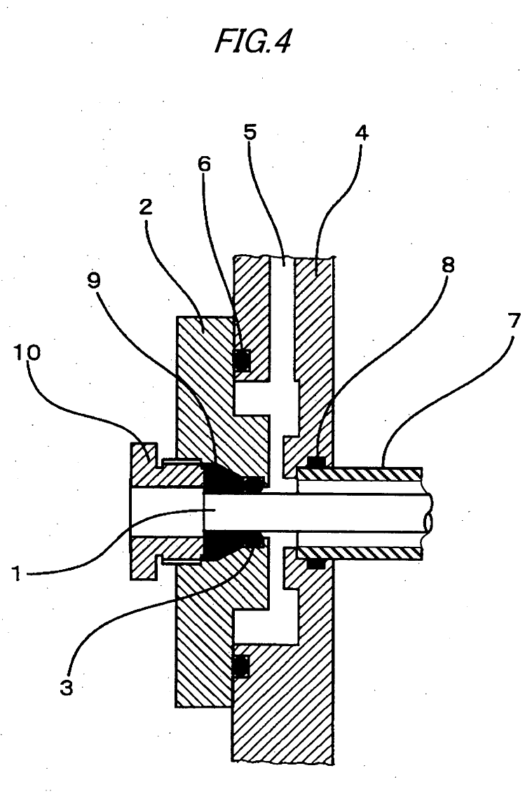

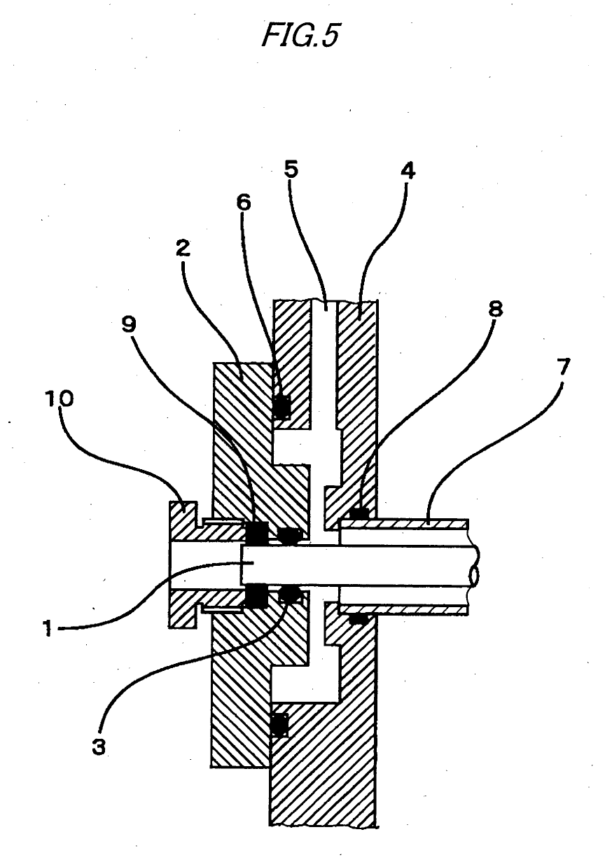

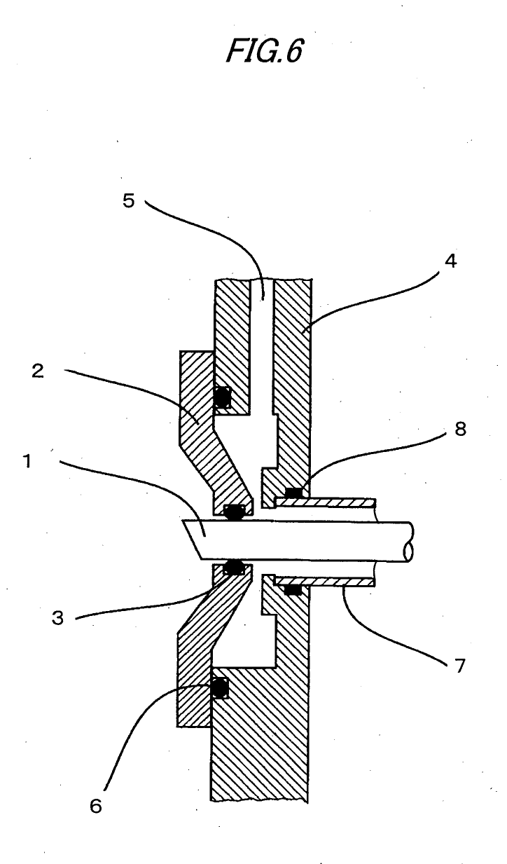

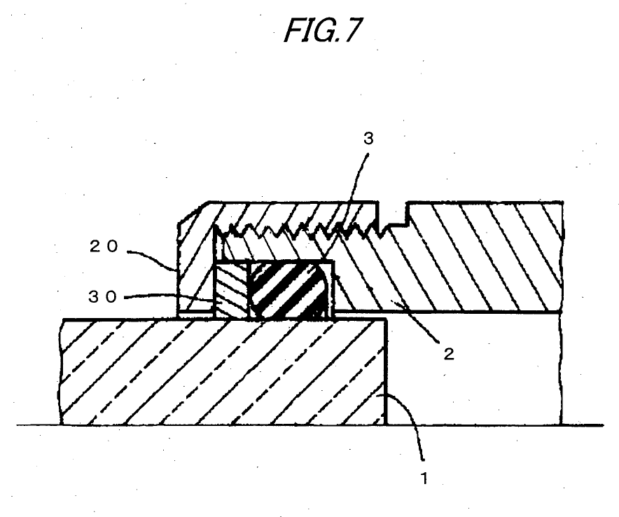

FIG. 1 is a sectional configuration view illustrating the structure of a rod-type solid-state laser apparatus in Embodiment 1 of the present invention. In this figure, numeral 1 denotes a rod-type solid-state laser medium, while numerals 9a, 9b denote fixing rings, placed around each end of the solid-state laser medium 1, whose surfaces facing the solid-state laser medium 1 have a cylindrical shape, and whose inner diameters are approximately equal to the diameter of the solid-state laser medium 1. The outer surfaces of the fixing rings 9a, 9b are partly tapered. Young's modulus of the fixing rings 9a, 9b is greater than or equal to 300 MPa and they consist of material whose Young's modulus is less than that of the solid-state laser medium 1. For example, white PTFE (poly(tetrafluoroetylene), (tetrafluorinated); Young's modulus: 390 MPa), which is a kind of fluorinated resin may be used as the material.

Numerals 2a, 2b denote rod holders provided with through-holes for positioning the fixing rings 9a, 9b and the solid-state laser medium 1, and the surfaces of the through-holes facing the fixing rings 9a, 9b are tapered at an angle approximately equal to the tapered outer surfaces of the fixing rings 9a, 9b. Numerals 4a, 4b denote side plates for fixing the rod holders 2a, 2b; numerals 5a, 5b denote coolant water channels provided in the side plates 4a, 4b for supplying or discharging the coolant medium which cools the solid-state laser medium 1; numerals 6a, 6b denote rod-holder O-rings that, when rod-holders 2a, 2b are fixed to the side plates 4a, 4b, are used to seal in the coolant medium; numeral 7 denotes a flow tube provided for circulating the coolant medium around the solid-state laser medium 1, wherein the solid-state laser medium 1 is fixed via the fixing rings 9a, 9b to the rod holders 2a, 2b so as to be enclosed by the flow tube 7. Numerals 8a, 8b denote flow-tube O-rings that are used to seal in the coolant medium when the flow tube 7 is fixed to the side plates 4a, 4b. Numerals 10a, 10b denote clamping fixtures, while numerals 11a, 11b denote clamping bolts; the clamping fixtures 10a, 10b and the clamping bolts 11a, 11b constitute pressuring members for pressing the fixing rings 9a, 9b against the tapered inner faces of the rod holders 2a, 2b, and also onto against the solid-state laser medium 1, and for fixing the solid-state laser medium 1 to the rod holders 2a, 2b. Numeral 12 denotes semiconductor lasers used for optical-pumping the solid-state laser medium 1; these are placed at three posi along the optical axis of the solid-state laser medium 1. Numeral 13 denotes a partial reflector which an optical resonator comprises, while numeral 14 denotes a partial reflector holder for fixing the partial reflector 13, and the holder has an adjusting mechanism for adjusting the position and angle of the partial reflector 13. Numeral 15 denotes another reflector that is total reflecting and which the optical resonator comprises, while numeral 16 denotes a total reflector holder for fixing the total reflector 15, and, similarly to the partial reflector holder 14, it has an adjusting mechanism for adjusting the position and angle of the total reflector 15. Numeral 17 denotes a base; and the side plates 4a, 4b, the partial reflector holder 14, and the total reflector holder 16 are securely fixed onto the common base 17. Numeral 18 denotes a laser beam extracted from the optical resonator that is comprised of the partial reflector 13 and the total reflector 15. In the rod-type solid-state laser of this embodiment, as shown in the figure, the solid-state laser medium support member configuration has the same right side and left side structures.

Next, the operation will be explained. When a pumping beam emitted from the semiconductor laser 12 is radiated onto the solid-state laser medium 1, active media contained in the solid-state laser medium 1 are pumped, and a population inversion is formed. When within the population inversion pumped particles located in an upper level relax to a lower level, spontaneous emission of light having a wavelength corresponding to the energy difference within the population inversion occurs. The partial reflector 13 is provided with a partially reflective coating for the wavelength corresponding to the energy difference within the population inversion; the total reflector 15 is provided with a fully reflective coating for the wavelength corresponding to the energy difference within the population inversion; and these compose the optical resonator. Part of the spontaneously emitted light generated in the solid-state laser medium 1 is confined within the optical resonator that is comprised of the partial reflector 13 and the total reflector 15, and it goes back and forth within the optical resonator. When the spontaneously emitted light going back and forth in the optical resonator passes through the population inversion formed by the active media, an amplifying action by the stimulated emission occurs, and the light strength within the optical resonator increases rapidly. With the increasing light strength, the phase-matched laser beam grows and this results in a laser oscillation. The laser beam in the optical resonator is extracted as a laser beam 18 to outside the optical resonator in a proportion corresponding to the transmittance of the partial reflector 13.

Since the solid-state laser medium 1, pumped by the semiconductor lasers 12, generates heat due to the presence of non-radiant transitions, it is cooled by purified water as coolant medium. The purified water as coolant medium is supplied from the coolant water channel 5a, and it cools the solid-state laser medium 1, passing between the flow tube 7 and the solid-state laser medium 1. The purified water that has cooled the solid-state laser medium 1 is discharged from the coolant water channel 5b.

In this embodiment, both ends of the solid-state laser medium 1 are supported by the rod holders 2a, 2b using the fixing rings 9a, 9b, whose outer surfaces are partially tapered. That is to say, the through-holes in the centers of rod-holders 2a, 2b are tapered at an angle which is approximately equal to the outer surface of the fixing rings 9a, 9b; the fixing rings 9a, 9b are fitted at both ends of the solid-state laser medium 1; using the clamping fixtures 10a, 10b, the fixing rings 9a, 9b are pressed toward the centers of the through-holes of the rod-holders 2a, 2b by means of the clamping bolts 11a, 11b; as a result, the fixing rings 9a, 9b are pressed against the tapered inner faces of the rod-holders 2a, 2b and against the solid-state laser medium 1, and the tapered part of the outer surfaces of the fixing rings 9a, 9b, and the tapered part of the through-holes in the rod holders 2a, 2b, are brought into sealing contact, as are the cylindrical inner surfaces of the through holes, which have an inner diameter approximately equal to the diameter of the solid-state laser medium 1 mounted in the center of the fixing rings 9a, 9b, and the outer surface of the solid-state laser medium 1; whereby both ends of the solid-state laser medium 1 are securely fixed to the rod holders 2a, 2b, and the purified water which is the coolant medium is sealed against leaking to the outside.

In this embodiment, the fixing rings 9a, 9b, whose outer surfaces are tapered, are fitted at both ends of the solid-state laser medium 1, and by pressing them onto the tapered sections provided in the through-holes of the rod-holders 2a, 2b, the solid-state laser medium 1 is fixed to the rod holders 2a, 2b; and consequently, it is possible to keep effectively under control solid-state laser medium vibration that accompanies direct collision of coolant-water against the medium, turbulence in cooling, and other external mechanical disturbances, and the solid-state laser medium can be stably supported. As a result, it is always possible to stably maintain constant laser output power.

In addition, since the outer surfaces of the fixing rings 9a, 9b and sections of the through-holes provided in the rod holders 2a, 2b are tapered at an approximately equal angle, even when replacing the solid-state laser medium 1, it is always possible to re-fix it in a constant position and to always obtain stable laser output power.

Even in a configuration where a plurality of the solid-state laser media 1 is arranged in series to obtain high laser output power, it is possible to maintain the central optical axis of each solid-state laser medium 1 in a constant and coaxial position, and to efficiently extract laser beams from the population inversion formed in each solid-state laser medium.

In this embodiment, since material whose Young's modulus is greater than or equal to 300 MPa and less than the Young's modulus of the solid-state laser medium is used for the fixing rings 9a, 9b that fix both ends of the solid-state laser medium 1, it is possible to securely fix both ends of the rod-type solid-state laser medium 1. In conventional rod-type lasers, both ends of the solid-state laser medium 1 are fixed with O-rings, but an elastomer such as silicone rubber is generally used as a material for the O-rings, which are composed of a soft material. In this embodiment, on the other hand, since fixing members composed of highly rigid material are used, completely different from the material of the above mentioned O-rings, the laser medium can be fixed securely. Therefore, it is possible to effectively suppress the solid-state laser medium vibration which accompanies coolant-water direct collision, turbulent cooling, and other external mechanical disturbances, and to always stably maintain constant laser output power.

When white PTFE, being a kind of fluorinated resin, is used as material for the fixing rings 9a, 9b, because the white PTFE, being a kind of fluorinated resin, has high reflectance with respect to light of wavelength close to 1 micrometer and has excellent thermal resistance, even if it is located close to the laser light, it is possible to constantly maintain stable laser generation without giving rise to heat degeneration or degassing.

In addition, since the fluorinated resin is also excellent owing to the stability and chemical resistance of the material, even if it is located in a situation where it is in constant contact with the cooling water, it is possible to avoid giving rise to corrosion or degradation, to maintain the electrical conductivity of the purified water at a lower value and to keep the coolant medium clean.

In this embodiment, since the fixing ring surfaces that face the solid-state laser medium have cylindrical shapes, wide surface contact areas with the solid-state laser medium can be realized, as compared with O-rings, and both ends of the rod-type solid-state laser medium 1 can be fixed securely. Therefore, it is possible to keep effectively under control solid-state laser medium vibration that accompanies coolant-water direct collision, turbulence in cooling, or other external mechanical disturbances, and to always stably maintain constant laser output power.

Fixing rings with partly tapered outer surfaces are represented in this embodiment; however, fixing rings with fully tapered outer surfaces may be also used.

Embodiment 2.

FIG. 2 is a sectional configuration view illustrating the structure of a solid-state laser medium support member for a rod-type solid-state laser apparatus in Embodiment 2 of the present invention. Although FIG. 2 illustrates a support configuration for the left extremity of the solid-state laser medium, the right extremity of the solid-state laser medium is also supported by a similar configuration. In this figure, numeral 2 denotes a rod holder, numeral 4 denotes a side plate, numeral 5 denotes a water coolant channel, numeral 6 denotes a rod-holder O-ring, numeral 8 denotes a flow-tube O-ring, numeral 9 denotes a fixing ring, and numeral 10 denotes a clamping fixture.

In the previously described Embodiment 1 as illustrated in FIG. 1, the solid-state laser medium 1 is fixed using the clamping bolts 11a, 11b, by inserting the clamping fixtures 10a, 10b into the through-holes of the rod holders 2a, 2b, and compressing the fixing rings 9a, 9b. This Embodiment 2 has a configuration that, by providing female threads in a through-hole in the rod holder 2 and male threads on the outer surface of the clamping fixture 10, and by screwing the clamping fixture 10 into the through-hole of the rod holder 2, compresses the fixing ring 9 to fix the solid-state laser medium 1 to the rod holder 2.

As represented in Embodiment 2, even with the configuration in which the female threads are provided in the through-hole of the rod holder 2 and the male threads are provided on the outer surface of the clamping fixture 10, and the clamping fixture 10 is screwed into the through-hole of the rod-holder 2, not only similar effects to those of Embodiment 1 can be obtained, but also, since it is not necessary to use a holding bolt, the fixing ring 9 can easily be compressed and the solid-state laser medium 1 can be fixed to the rod holder 2. Therefore, the solid-state laser medium 1 can be easily installed or replaced, and the maintainability of the rod-type solid-state laser apparatus can be improved.

Embodiment 3

FIG. 3 is a sectional configuration view illustrating the structure of a solid-state laser medium support member for a rod-type solid-state laser apparatus in Embodiment 3 of the present invention. Although FIG. 3 illustrates a support configuration for the left extremity of the solid-state laser-medium, the right extremity of the solid-state laser medium is supported by a similar configuration. In Embodiment 3, a rectangular space (an O-ring channel) is provided along the small-diameter side of the tapered inner surface of the through-hole in the rod holder 2, and an O-ring 3 is set in the O-ring channel. A compressing method for the fixing ring 9 is the same as in Embodiment 2, as illustrated in FIG. 2.

In Embodiment 3, purified water, a coolant medium, is sealed by the O-ring 3. Moreover, accurate positioning of the end portion of the solid-state laser-medium and fixing of the solid-state laser medium is achieved by the fixing ring 9 which has a tapered outer surface.

In situations where the fixing ring 9 has double functions of fixing the solid-state laser medium 1 and of sealing the coolant medium, in order to prevent leakage of the coolant medium, it is necessary to sufficiently compress and deform the fixing ring 9 by means of the clamping fixture 10, and to keep the rod holder 2 and the fixing ring 9, and the fixing ring 9 and the solid-state laser medium 1, in very close contact with each other. As a result, stresses that accompany the strong pressure on the fixing ring 9 are generated in the end portion of the solid-state laser medium 1, and optical distortion that accompanies optical-elastic effects are generated inside the solid-sate laser medium 1, and it becomes difficult to stably generate a highly focused laser beam. In Embodiment 3, since the coolant medium is sealed by using the O-ring 3 separately from the fixing ring 9, the force compressing the fixing ring 9 can accurately position the solid-state laser medium 1 and can also suppress vibration and optical axis eccentricity with minimum force, so that the stresses on the solid-state laser medium 1 can be reduced and the optical distortion generation can be suppressed; and therefore in the configuration in which the end portion of the solid-state laser medium 1 is fixed using the fixing ring 9, it is possible to generate a stable laser beam without deterioration in light focusability.

Embodiment 4

FIG. 4 is a sectional configuration view illustrating the structure of a solid-state laser medium support member for a rod-type solid-state laser apparatus in Embodiment 4 of the present invention. Although FIG. 4 illustrates a support configuration for the left extremity of the solid-state laser-medium, the right extremity of the solid-state laser medium is supported by a similar configuration. In Embodiment 4, a coolant medium is sealed by using an O-ring 3, similar to above Embodiment 3 as illustrated in FIG. 3. However, for the rod-type solid-state laser apparatus in this embodiment, for setting the O-ring 3, an O-ring groove provided inside the through-hole of a rod holder 2 does not have a rectangular cross-sectional shape, but forms a space opening on the small-diameter side of the tapered inner surface, inside the through-hole of the rod holder 2, and the O-ring 3 is set inside this space. The O-ring 3 mounted at the tip portion of the solid-state laser medium 1 is configured to be pushed into the space by means of the fixing ring 9.

As illustrated in Embodiment 4, with a configuration in which the O-ring 3 for sealing in the coolant medium is set inside a space communicating with the tapered inner surface of the rod holder 2, when manufacturing the rod holder 2, machining becomes easy and manufacturing cost can be reduced.

Moreover, since the O-ring 3 may be mounted at the tip portion of the solid-state laser medium 1 and pushed into the space by the fixing ring 9, installing or replacing the solid-state laser medium 1 can be easily carried out.

In Embodiment 4, it is clear that similar advantages to above Embodiment 3 can be obtained.

In Embodiments 3 and 4, while compressing of the fixing ring 9 is carried out by the configuration as illustrated in FIG. 2, it is clear that it may also be carried out using a similar configuration to that of Embodiment 1, as illustrated in FIG. 1.

Embodiment 5

FIG. 5 is a sectional configuration view illustrating the structure of a solid-state laser medium support member for a rod-type solid-state laser apparatus in Embodiment 5 of the present invention. Although FIG. 5 illustrates a support configuration for the left extremity of the solid-state laser-medium, the right extremity of the solid-state laser medium is supported by a similar configuration. In Embodiment 5, neither the inner surface of the through-hole in the rod holder 2 nor the outer surface of the fixing ring 9 is tapered. On the inner surface of the through-hole in the rod holder 2, a space for the fixing ring 9 and a space for the O-ring 3 are provided, and the inner diameter of the space in which the fixing ring 9 is arranged is constant. The outer diameter of the fixing ring 9 is approximately 0.05 mm-0.1 mm less than the inner diameter of the space in which the fixing ring 9 is arranged, provided in the rod-holder 2, and the inner diameter of the fixing ring 9 (the through-hole diameter) is approximately 0.05 mm-0.1 mm greater than the outer diameter of the solid-state laser medium 1, and the fixing ring has a cylindrical shape. Accordingly, the through-hole of the rod-holder 2 and the outer diameter of the fixing ring 9, and the through-hole of the fixing ring 9 and the outer diameter of the solid-state laser medium 1 have so-called mating relationships. The fixing ring 9 material consists of material having a Young's modulus greater than or equal to 300 MPa and less than the Young's modulus of the solid-state laser medium 1, similar to Embodiment 1. As the base material, white PTFE, which is a kind of fluorinated resin, may for example be used.

In this embodiment, the fixing ring 9 is compressed against the inner surface of the rod holder 2 by the clamping fixture 10 and fixes the solid-state laser medium 1 to the rod holder 2. That is, by compressing the fixing ring 9 in the longitudinal direction of the solid-state laser medium 1 by means of the clamping fixture 10, and by pressing the fixing ring 9 against the inner face of the rod holder 2, elastic deformation occurs in the fixing ring 9, the outer diameter of the fixing ring 9 increases, and the inner diameter decreases. Consequently, since the cylindrical outer surface of the fixing ring 9 and the cylindrical inner surface of the through-hole of the rod holder 2, and the cylindrical inner surface of the through-hole of the fixing ring 9 and the outer surface of the solid-state laser medium 1 are brought into sealing contact, it is possible to securely fix the solid-state laser medium 1 with respect to the rod holder 2.

As a result, it is possible to keep effectively under control solid-state laser medium vibration that accompanies coolant-water direct collision, turbulence in cooling and other mechanical disturbances, and the solid-state laser medium can be stably supported and constant laser output power can always be stably maintained.

In Embodiment 5, since material having a Young's modulus greater than or equal to 300 MPa and less than the Young's modulus of the solid-state laser medium is used for the fixing ring 9, it has higher rigidity compared to materials such as silicone rubber used in conventional O-rings, and both ends of the rod-type solid-state laser medium can be securely fixed. Therefore, it is possible to keep effectively under control solid-state laser medium vibration that accompanies coolant-water direct collision, turbulence in cooling and other mechanical disturbances, and to stably maintain constant laser output power.

In Embodiment 5, since purified water as coolant medium is sealed by the O-ring 3 and the solid-state laser medium is fixed by the cylindrical fixing ring 9, the force for compressing the solid-state laser medium by means of the fixing ring 9 can be kept at a minimum level. Therefore, when fixing the solid-state laser medium, stresses on the solid-state laser medium are reduced and optical distortion generation can be effectively suppressed, and it is possible to stably generate a highly focused laser beam.

Moreover, in Embodiment 5, since neither the through-hole provided in the rod holder 2 nor the outer surface of the fixing ring 9 is tapered, the rod holder 2 and the fixing ring 9 are easy to produce, and the manufacturing cost can be reduced.

Although both the cylindrical fixing ring 9 and the O-ring 3 provided are represented in Embodiment 5, by increasing due to the pressing force of the clamping fixture 10 to give the coolant-medium sealing function to the cylindrical fixing ring 9, a configuration without the O-ring 3 is also feasible.

In addition, although a configuration in which both the inner diameter of the through-hole provided in the rod holder 2 and the outer diameter of the fixing ring 9 are constant is represented in this embodiment, fixing methods for the solid-state laser medium 1 are in no way intended to be considered limiting, and, for example, the outer diameter of the fixing ring 9 may be tapered while the inner diameter of the through-hole provided in the rod holder 2 may be made constant; or conversely, the outer diameter of the fixing ring 9 may be constant while the inner diameter of the through-hole provided in the rod holder 2 may be tapered. That is, the shape of the space of the rod holder and the shape of the outer surface of the fixing ring may be different, and a part of the fixing ring may be configured to press upon the inner surface of the rod holder.

Although the fixing rings in Embodiments 1-5 have been illustrated as all-in-one fixing rings with through-holes, fixing rings arranged segmentally around the solid-state laser medium 1 are also feasible.

More over, although Embodiments 1-5 illustrate the solid-state laser-medium being pumped by a semiconductor laser beam, lasers exited by other pumping sources, such as lamps, may be also used.

### INDUSTRIAL APPLICABILITY

A rod-type solid-state laser apparatus according to the present invention is not only related to rod-type solid-state laser apparatuses for manufacturing processes but may also be applied to rod-type solid-state laser apparatuses for uses such as remote sensing, spectroscopy, medical services and others types of uses.

1. A rod-shaped solid-state laser apparatus comprising:
a rod-shaped solid-state laser medium having an outer diameter and pumped by a semiconductor laser;
a pair of fixing rings, each fixing ring being placed around a respective end of the solid-state laser medium and having an inner diameter approximately equal to the outer diameter of the solid-state laser medium, and having an outer surface, at least part of which is tapered;
a pair of plates, each plate being placed around one of the fixing rings and having a tapered inner face facing the fixing ring and tapered at an angle approximately equal to the tapered outer face of the fixing ring; and
a pair of pressing members, each pressing member pressing one of the fixing rings against one of the plates on the tapered inner face and against the solid-state laser medium, fixing the solid-state laser medium to the rod holder.

2. A rod-shaped solid-state laser apparatus comprising:
a rod-shaped solid-state laser medium having an outer diameter and pumped by a semiconductor laser;
a pair of fixing rings, each fixing ring being placed around a respective end of the solid-state laser medium and having an inner diameter approximately equal to the outer diameter of the solid-state laser medium, and composed of material having a Young's modulus no smaller than 300 MPa and less than the Young's modulus of the solid-state laser medium;
a pair of plate-shaped rod holders, each plate-shaped rod holder placed around one of the fixing rings and having a tapered inner face; and
a pair of pressing members, each pressing member pressing one of the fixing rings against the tapered inner face of one of the rod holders and against the solid-state laser medium, fixing the solid-state laser medium to the rod holder.

3. A rod-shaped solid-state laser apparatus comprising:
a rod-shaped solid-state laser medium having an outer diameter and pumped by a semiconductor laser;
a pair of fixing rings, each fixing ring being placed around a respective end of the solid-state laser medium and having an inner diameter approximately equal to the outer diameter of the solid-state laser medium, and including a cylindrically shaped face facing the solid-state laser medium;
a pair of plate-shaped rod holders, each plate-shaped rod holder being placed around one of the fixing rings and having a tapered inner face; and
a pair of pressing members, each pressing member pressing one of the fixing rings against the tapered inner face of one of the rod holders and against the solid-state laser medium, fixing the solid-state laser medium to the rod holder.

4. The rod-shaped solid-state laser apparatus according to claim 1, wherein the rod holder includes a space for retaining an O-ring and an O-ring set in the space, sealing out a coolant medium that cools the solid-state laser medium.

5. The rod-shaped solid-state laser apparatus according to claim 1, wherein the fixing ring is material having a Young's modulus no smaller than 300 MPa, and less than the Young's modulus of the solid-state laser medium.

6. The rod-shaped solid-state laser apparatus according to claim 1, wherein a face of the fixing ring, which faces the solid-state laser medium, has a cylindrical shape.

7. The rod-shaped solid-state laser apparatus according to claim 1, wherein the fixing ring is a fluorinated resin.

8. (Canceled)

9. The rod-shaped solid-state laser apparatus according to claim 1, wherein the outer diameter is less than 4 mm.

10. The rod-shaped solid-state laser apparatus according to claim 1, further comprising a base to which the plate-shaped rod holder is fixed by screws.

11. The rod-shaped solid-state laser apparatus according to claim 2, wherein the outer diameter is less than 4 mm.

12. The rod-shaped solid-state laser apparatus according to claim 2, wherein the rod holder includes a space for retaining an O-ring and an O-ring set in the space sealing out a coolant medium that cools the solid-state laser medium.

13. The rod-shaped solid-state laser apparatus according to claim 2, wherein a face of the fixing ring, which faces the solid-state laser medium, has a cylindrical shape.

14. The rod-shaped solid-state laser apparatus according to claim 2, wherein the fixing ring is a fluorinated resin.

15. The rod-shaped solid-state laser apparatus according to claim 2, further comprising a base to which the plate-shaped rod holder is fixed by screws.

16. The rod-shaped solid-state laser apparatus according to claim 3, wherein the outer diameter is less than 4 mm.

17. The rod-shaped solid-state laser apparatus according to claim 3, wherein the rod holder includes a space for retaining an O-ring and an O-ring set in the space sealing out a coolant medium that cools the solid-state laser medium.

18. The rod-shaped solid-state laser apparatus according to claim 3, wherein the fixing ring is a fluorinated resin.

19. The rod-shaped solid-state laser apparatus according to claim 3, further comprising a base to which the plate-shaped rod holder is fixed by screws.
